(19) United States
(12) Patent Application Publication
(10) Pub. No.: US 2010/0079589 A1
(43) Pub. Date: Apr. 1, 2010

(54) Imaging Apparatus And Mode Appropriateness Evaluating Method

(75) Inventors: Masahiro YOSHIDA, Osaka (JP); Tomoki OKU, Osaka (JP); Kazuma HARA, Osaka (JP); Makoto YAMANAKA, Osaka (JP)

Correspondence Address: NDQ&M WATCHSTONE LLP, 1300 EYE STREET, NW, SUITE 1000 WEST TOWER, WASHINGTON, DC, 20005, US

(73) Assignee: SANYO ELECTRIC CO., LTD., Osaka (JP)

(21) Appl. No.: 12/567,286

(22) Filed: Sep. 25, 2009

(30) Foreign Application Priority Data
Sep. 26, 2008 (JP) 2008248987

(51) Int. Cl. H04N 7/18; H04N 5/228

(52) U.S. Cl. 348/81; 348/222.1; 348/E05.031; 348/E07.085

(57) ABSTRACT

An imaging apparatus incorporating a plurality of scene modes is provided with: an automatic appropriate mode determining portion that, while shooting of a moving image is in progress, automatically determines at least one scene mode appropriate for a shooting scene of the moving image; and a scene mode comparison portion that compares a currently selected scene mode with the at least one scene mode automatically determined by the automatic appropriate scene mode determining portion, and that thereby confirms whether or not the currently selected scene mode corresponds to any one of the at least one scene mode automatically determined by the automatic appropriate scene mode determining portion.

This nonprovisional application claims priority under 35 U.S.C. §119(a) on Patent Application No. 2008-248987 filed in Japan on Sep. 26, 2008, the entire contents of which are hereby incorporated by reference.

### BACKGROUND OF THE INVENTION

1. Field of the Invention

The present invention relates to an imaging apparatus incorporating a plurality of scene modes, and to a scene mode appropriateness evaluating method for evaluating whether or not a scene mode selected by such an imaging apparatus is appropriate. Moreover, the present invention is applicable to any other electronic device (e.g., IC recorder, etc.) incorporating a plurality of recording modes, and to a recording mode appropriateness evaluating method for evaluating whether or not a recording mode selected by such an electronic device is appropriate.

2. Description of Related Art

Most of digital video cameras incorporate a plurality of scene modes such as “Sports,” “Portrait,” “Landscape,” and “Underwater” each associated with differently categorized shooting scenes, and thus are capable of enabling a setting of camera control, image quality control, and audio control appropriately for each of the shooting scenes. A photographer supposes beforehand the kind of scene that he or she wishes to shoot, and then proceeds with video shooting after selecting a scene mode appropriate for that supposed scene.

A scene mode selected by a photographer is, however, not always appropriate; for example, if a photographer forgets beforehand newly selecting a scene mode appropriate for his or her supposed shooting scene, shooting is carried out while a previously selected scene mode is maintained. To avoid such a mistake, in some digital cameras (including digital steel cameras and digital video cameras), whether or not a predetermined scene mode (macro shooting mode or high-sensitive shooting mode) is selected is detected; if the predetermined scene mode is selected, whether or not the predetermined scene mode is inappropriate for a target shooting scene is determined; if the predetermined scene mode is inappropriate, a warning display is shown.

In fact, such a digital camera as described above simply analyzes a shooting scene immediately before carrying out shooting, and thus cannot cope with a case where a shooting scene is varied over time during video shooting. For example, when a photographer moves from a dim room to a bright outside while shooting a moving image, that shooting is carried out with a setting of white balance appropriate for “indoor,” and an optimum moving image cannot be recorded accordingly. Moreover, most of the digital video cameras that are equipped with a waterproof capability or that can be housed inside a waterproof enclosure normally incorporate “Underwater” mode optimum for underwater shooting. However, shooting does not always take place underwater when it comes to shooting in shallow water for example, and the cameras are likely to come in and out of water repeatedly. In this case, it is desirable that “Underwater” mode be released when the cameras come out of water.

### SUMMARY OF THE INVENTION

An object of the present invention is to provide an imaging apparatus that, while shooting a moving image, can determine whether or not a scene mode selected by the imaging apparatus is appropriate, and to provide a scene mode appropriateness evaluating method for evaluating whether or not a scene mode selected by such an imaging apparatus is appropriate.

To achieve the above-described object, according to the present invention, an imaging apparatus incorporating a plurality of scene modes, includes: an automatic appropriate scene mode determining portion that, while shooting of a moving image is in progress, automatically determines at least one scene mode appropriate for a shooting scene of the moving image; and a scene mode comparison portion that, while the shooting of the moving image is in progress, compares a currently selected scene mode with the at least one scene mode automatically determined by the automatic appropriate scene mode determining portion, and that thereby confirms whether or not the currently selected scene mode corresponds to any one of the at least one scene mode automatically determined by the automatic appropriate scene mode determining portion.

Moreover, to achieve the above-described object, according to the present invention, in an imaging apparatus incorporating a plurality of scene modes, a scene mode appropriateness evaluating method for evaluating whether or not a scene mode currently selected by the imaging apparatus is appropriate, includes the steps of: while shooting of a moving image is in progress, (1) automatically determining at least one scene mode appropriate for a shooting scene, and (2) comparing whether or not the currently selected scene mode with the at least one scene mode automatically determined in the step (1), and thereby confirming whether or not the currently selected scene mode corresponds to any one of the at least one scene mode automatically determined in the step (1).

### BRIEF DESCRIPTION OF THE DRAWINGS

FIG. 1 is a block diagram showing an example of an internal configuration of an imaging apparatus embodying the present invention;

FIG. 2 is a block diagram showing a configuration of a first example of a scene mode appropriateness evaluating portion;

FIG. 3 shows examples of how to give a warning;

FIG. 4 shows an example of giving a warning and prompting a mode change through a monitor display;

FIG. 5 is a flowchart depicting a flow of operations for shooting performed by the imaging apparatus shown in FIG. 1 and adopting the first example of the scene mode appropriateness evaluating portion;

FIG. 6 is a block diagram showing a second example of the scene mode appropriateness evaluating portion;

FIG. 7 is a flowchart depicting a flow of operations for shooting performed by the imaging apparatus shown in FIG. 1 and adopting the second example of the scene mode appropriateness evaluating portion;

FIG. 8 shows a configuration of parts of the imaging apparatus involved in switching white balance adjustment depending on whether or not a selected scene mode is “Underwater”;

FIG. 9 shows a configuration of parts of the imaging apparatus involved in switching sound processing depending on whether or not a selected scene mode is “Underwater”;

FIG. 10 is a graph showing in-air sound frequency characteristics;

FIG. 11 is a graph showing underwater sound frequency characteristics;

FIG. 12 shows a difference between in-air and underwater sound frequency characteristics;

FIG. 13 is a diagram showing a first example of an underwater noise reduction portion;

FIG. 14 is a diagram showing a second example of the underwater noise reduction portion; and

FIGS. 15A and 15B each show how a sound is transmitted from a noise source of the imaging apparatus, and how a sound is transmitted from a sound source from which a sound to be collected originates.

### DETAILED DESCRIPTION OF PREFERRED EMBODIMENTS

Hereinafter, an embodiment of the present invention will be described with reference to the accompanying drawings.

<Basic Configuration of an Imaging Apparatus>

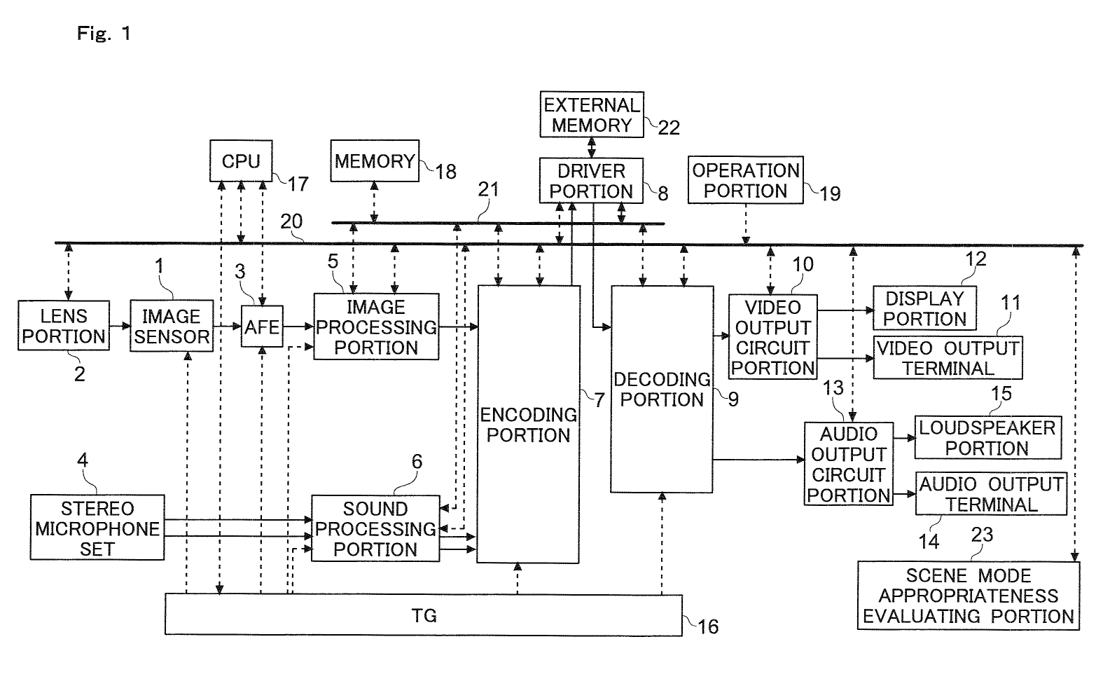

First, a basic configuration of an imaging apparatus will be described with reference to FIG. 1. FIG. 1 is a block diagram showing by way of example an internal configuration of an imaging apparatus according to the present invention.

The imaging apparatus shown in FIG. 1 is provided with: a solid-state imaging element (image sensor) 1, such as a CCD (charge coupled device) or a CMOS (complimentary metal oxide semiconductor), converting light incident thereon into an electrical signal; a lens portion 2 including a zoom lens allowing an optical image of a subject to be formed on the image sensor 1, a motor for varying a focal length of the zoom lens, namely optical zoom magnification power, and a motor for focusing the zoom lens on the subject; an AFE (analog front end) 3 converting an image signal which is an analog signal fed from the image sensor 1, into a digital signal; a stereo microphone set 4 converting sounds received from a left-front side and a right-front side of the imaging apparatus separately into electrical signals; an image processing portion 5 performing various kinds of image processing, including gradation correction, on the image signal which is a digital signal fed from the AFE 3; a sound processing portion 6 converting a sound signal which is an analog signal fed from the stereo microphone set 4, into a digital signal, and performing sound compensation processing on the digital signal; an encoding portion 7 performing compression-encoding processing, by MPEG (moving picture experts group) encoding technique and the like, on the image signal fed from the image processing portion 5 and the sound signal fed from the sound processing portion 6; a driver portion 8 permitting an encoded signal encoded by the encoding portion 7 to be stored in an external memory 22 such as an SD card; a decoding portion 9 performing decompression-decoding processing on the encoded signal read from the external memory 22 by use of the driver portion 8; a video output circuit portion 10 converting a signal decoded by the decoding portion 9, into an analog signal; a video output terminal 11 outputting a signal converted by the video output circuit portion 10; a display portion 12 equipped with an LCD (liquid crystal display) and the like where an image is displayed based on a signal fed from the video output circuit portion 10; an audio output circuit portion 13 converting a sound signal fed from the decoding portion 9 into an analog signal; an audio output terminal 14 outputting a signal converted by the audio output circuit portion 13; a loudspeaker 15 reproducing and outputting a sound based on the sound signal fed from the audio output circuit portion 13; a timing generator (TG) 16 outputting a timing control signal for synchronizing operational timings of individual blocks; a CPU (central processing unit) 17 controlling all enabling/disabling operations of the imaging apparatus; a memory 18 in which various programs for performing each operation are stored, and in which data for use in executing the programs is temporarily stored; an operation portion 19 through which a command from a photographer is entered; a bus line 20 for exchanging data between the CPU 17 and individual blocks; a bus line 21 for exchanging data between the memory 18 and individual blocks; and a scene mode appropriateness evaluating portion 23. The CPU 17 performs focus control and aperture control by driving each of the motors inside the lens portion 2, in accordance with an image signal detected by the image processing portion 5.

<Basic Operations of the Imaging Apparatus>

Next, basic operations performed by the imaging apparatus, shown in FIG. 1, when shooting a moving image will be described with reference to FIG. 1. First, in the imaging apparatus, the image sensor 1 performs photoelectric conversion on light received from the lens portion 2 whereby image signals, which are electrical signals, are obtained. The image sensor 1 takes synchronization with a timing control signal fed from the timing generator 16, and thereby outputs the image signals to the AFE 3 sequentially every predetermined frame period (e.g., 1/60 seconds). The CPU 17 performs camera control (AF, AE, ISO sensitivity, etc.) on the image sensor 1 and the lens portion 2 in accordance with a selected scene mode.

Subsequently, the AFE 3 performs analog-to-digital conversion on the image signal, and then inputs a resulting converted signal to the image processing 5. The image processing portion 5 converts the image signal into an image signal composed of a luminance signal and a color-difference signal, and performs various kinds of image processing, such as gradation correction and contour emphasis, on it. The memory 18 functions as a frame memory, and temporarily stores the image signal while the image processing portion 5 engages in its processing. The image processing portion 5 performs image processing in accordance with a selected scene mode.

Meanwhile, in the lens portion 2, based on the image signal fed to the image processing portion 5, focus adjustment is performed by adjusting a position of each lens, and exposure adjustment is performed by adjusting an aperture opening. The focus adjustment and exposure adjustment are individually performed automatically based on predetermined programs so that focus and exposure are in optimum conditions, or they are performed manually based on commands from a photographer.

On the other hand, the sound signal converted by the stereo microphone set 4, where it is converted into an electrical signal, is fed to the sound processing portion 6. The sound processing portion 6 converts the sound signal so received into a digital signal, and performs sound compensation processing, such as noise elimination and intensity control, on the sound signal. The sound processing portion 6 performs sound processing in accordance with a selected scene mode.

The image signal outputted from the image processing portion 5 and the sound signal outputted from the sound processing portion 6 are fed to the encoding portion 7, where they are encoded by a predetermined encoding technique. Meanwhile, the image signal and the sound signal are associated with each other in temporal terms, so that image and sound do not go out of synchronization with each other when played back. Subsequently, the image and sound signals thus encoded are stored in the external memory 22 via the driver portion 8.

The encoded signal so stored in the external memory 22 is read therefrom to the decoding portion 9 in accordance with an output signal produced by the operation portion 19 based on a command from a photographer. The decoding portion 9 decompresses and decodes the encoded signal, and thereby generates an image signal and a sound signal. The image and sound signals are fed to the video and audio output circuit portions 10 and 13, respectively. By the video output circuit 10 and the audio output circuit portion 13, the image and sound signals are converted into formats such that they can be played back by the display portion 12 and the loudspeaker portion 15, respectively.

Moreover, in a case where a photographer checks an image simply displayed on the display portion 12, without recording, in so-called preview mode, it is preferable that the encoding processing portion 7 do not perform compression-encoding processing, and that the image processing portion 5 output the image signal, not to the encoding portion 7, but to the video output circuit portion 10. Furthermore, when the image signal is stored in the external memory 22, it is preferable that the image signal be stored in the external memory 22 via the driver portion 8, and be simultaneously outputted to the display portion 12 via the video output circuit 10.

According to the configuration shown in FIG. 1, the display portion 12 and the loudspeaker 15 are incorporated in the imaging apparatus. They may be provided separately from the imaging apparatus, and may be connected to the imaging apparatus by use of a plurality of terminals (i.e., video output terminal 11 and audio output terminal 14) provided in the imaging apparatus, cables and the like.

<First Example of the Scene Mode Appropriateness Evaluating Portion>

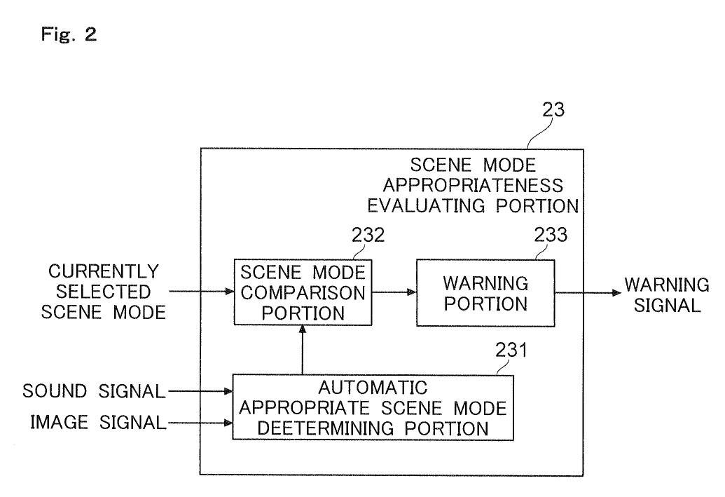

Next, a first example of the scene mode appropriateness evaluating portion 23 will be described with reference to FIG. 2. FIG. 2 is a block diagram showing a configuration of a first example of the scene mode appropriateness evaluating portion 23.

The scene mode appropriateness evaluating portion 23 shown in FIG. 2 is provided with: an automatic appropriate scene mode determining portion 231; a scene mode comparison portion 232; and a warning portion 233.

The automatic appropriate scene mode determining portion 231 automatically determines at least one scene mode appropriate for a shooting scene (hereinafter, called an appropriate scene mode) by analyzing sound and image signals being captured while shooting is performed, and by determining the kind of shooting scene. The number of appropriate scene modes determined by the automatic appropriate scene mode determining portion 231 may be single or may be plural. Specifically, the automatic appropriate scene mode determining portion 231 determines at least one appropriate scene mode by analyzing resonant and frequency characteristics of a sound and by determining the kind of target shooting scene (indoor, outdoor, underwater, etc.), and in addition, by analyzing not only basic characteristics including luminance and histogram of image information, but also other information such as whether or not a person is appearing in that scene. Although this example deals with a case where the sound and image signals are analyzed in software, the kind of target shooting scene may be determined in hardware, for example, by use of a pressure sensor, an illuminance sensor, and the like. Use of a pressure sensor, for example, makes it possible to determine whether shooting is performed underwater or in air, and use of an illuminance sensor, for example, makes it possible to determine whether shooting is performed indoor or outdoor, or whether at nighttime or at daytime.

The scene mode comparison portion 232 compares a scene mode currently selected by a photographer (hereinafter, called a currently selected scene mode) with an appropriate scene mode, at least one, automatically determined by the automatic appropriate scene mode determining portion 231, and then reports to the warning portion 233 on a result of the comparison, namely whether or not the currently selected scene mode corresponds to the appropriate scene mode (or, any one of the appropriate scene modes, if there is more than one). That is, if the currently selected scene mode does not correspond to the appropriate scene mode, the warning portion 233 given a warning. Specifically, the warning portion 233 gives a warning, for example, if the currently selected mode is “Landscape” when shooting is performed indoor, or if the currently selected mode is “Portrait” when no person is appearing in a target shooting scene.

<Examples of a Warning>

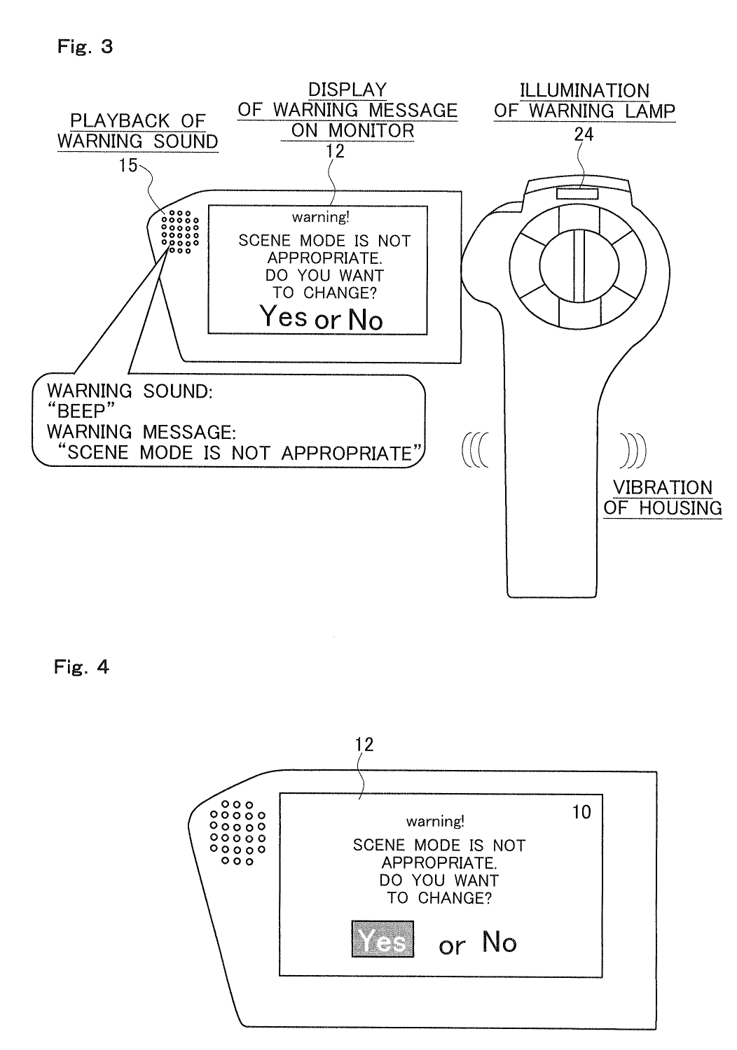

FIG. 3 shows examples of how to give a warning. A warning may be given to a photographer by implementing solely any one or a combination of ones selected from four examples shown in FIG. 3 (playback of a warning sound, etc., display of a warning message, etc. on a monitor, illumination of a warning lamp, and vibration of a housing), and others provided for this purpose.

In a case where a warning is given by playing back a sound, etc., the warning portion 233 feeds a sound signal, as a warning signal, that corresponds to a warning sound or a warning message, to the audio output circuit portion 13. Thus, the warning sound or the warning message is played back through the loudspeaker 15. For this, it is desirable that the sound processing portion 6 perform sound processing, such as noise cancellation, on the sound signal, so that the sound so played back is not recorded as shooting data.

In a case where a warning is given by displaying a warning message, etc. on a monitor, the warning portion 233 feeds an image signal, as the warning signal, that corresponds to a warning message, etc., to the video output circuit portion 10. Thus, the warning message, etc. is displayed on a screen of the display portion 12. In FIG. 3, a warning message is displayed on an entire area of the screen of the display portion 12; however, it may be shown in a small size at a corner of the screen so as not to hinder a preview display of an image being shot. Moreover, instead of displaying a warning message, a warning mark may be lighted up or flashed.

In a case where a warning is given by illumination of a warning lamp, a warning lamp 24 and a lamp driving portion for driving the warning lamp 24 are provided on and inside a body of the imaging apparatus, respectively, and to the lamp driving portion, the warning portion 233 feeds a lamp illumination signal as the warning signal. Thus, the warning lamp 24 illuminates (in a state of being lighted-on or flashed). For the warning lamp 24, a lamp specific to the warning may be provided, or a lamp which is normally used for a different application, and whose illumination color or flashing pattern is changed simply when a warning is given may be used.

In a case where a warning is given by vibrating the housing (body of the imaging apparatus), a vibration motor and a driving portion for the vibration motor are provided inside the body of the imaging apparatus and, to the motor driving portion, the warning portion 233 feeds a motor driving signal as the warning signal. Thus, the body of the imaging apparatus is vibrated. Meanwhile, camera shakes are produced; accordingly, it is desirable that the image processing portion 5 perform correction of the camera shakes.

<Processing after Giving a Warning>

If the currently selected scene mode does not correspond to the appropriate scene mode (or, any one of the appropriate scene modes, if there is more than one), after a warning is given as described above, one of the following operations is performed: the currently selected scene mode is maintained, the currently selected scene mode is changed to the appropriate scene mode (or, any one of the appropriate scene modes, if there is more than one), and a default scene mode is entered after the currently selected scene mode is released.

FIG. 4 shows an example of giving a warning and prompting a mode change through a monitor display. As shown in this figure, a photographer is given a warning that the currently selected scene mode is not appropriate, and is asked whether to change the currently selected scene mode. Subsequently, the photographer selects “Yes” or “No” by manipulating the operation portion 19.

If “Yes” is selected, the currently selected scene mode may be changed to the appropriate scene mode automatically determined by the automatic appropriate scene mode determining portion 231. For example, suppose that shooting is performed outdoor with a setting of “Indoor” mode, the currently selected scene mode may be changed to “Outdoor” mode. Or, a default scene mode (e.g., “Auto” mode) may be entered after the currently selected scene mode is released. For example, suppose that shooting is performed above water with a setting of “Underwater” mode, the default scene mode may be entered after “Underwater” mode is released.

A screen shown in FIG. 4 is provided with a time limit, and the time limit is displayed, as shown in the figure, at a top right corner of the screen while being counted down in units of seconds. If the time limit reaches zero with neither “Yes” or “No” selected by a photographer, it may be considered as selection of “Yes,” so that the currently selected scene mode is forcedly changed to the appropriate scene mode; otherwise, it may be considered as selection of “No,” so that assuming that a photographer has no intention to change the currently selected scene mode, the currently selected scene mode is maintained.

<Processing Flow for Operations Performed in Shooting>

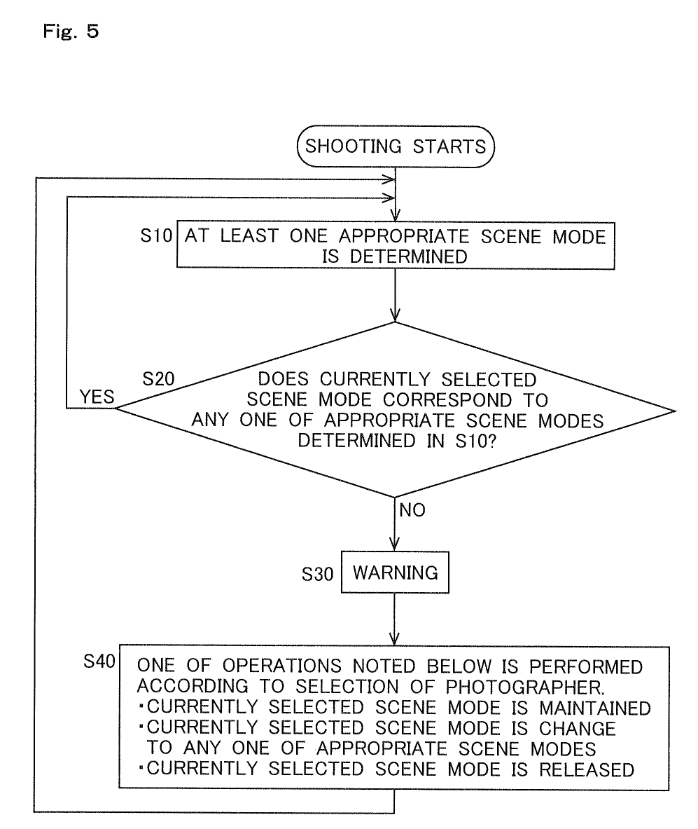

FIG. 5 is a flowchart depicting operations for shooting performed by the imaging apparatus shown in FIG. 1 and adopting the first example of the scene mode appropriateness evaluating portion 23.

When a photographer performs a shooting start operation through the operation portion 19, a processing flow depicted in FIG. 5 is started. The CPU 17 always monitors, based on an output from the operation portion 19, whether or not a photographer performs a shooting end operation through the operation portion 19. As soon as a photographer performs a shooting end operation through the operation portion 19, the processing flow depicted in FIG. 5 is interrupted, and ongoing shooting is stopped accordingly.

First, the automatic appropriate scene mode determining portion 231 automatically determines at least one appropriate scene mode (step S10). Subsequently, the scene mode comparison portion 232 compares the currently selected scene mode with the appropriate scene mode, and thereby determines whether or not the currently selected scene mode corresponds to the appropriate scene mode (or, any one of the appropriate scene modes, if there is more than one) (step S20).

If the currently selected scene mode corresponds to the appropriate scene mode (or, any one of the appropriate scene modes, if there is more than one) (Yes in step S20), the processing returns to step S10. Otherwise, if the currently selected scene mode does not correspond to the appropriate scene mode (or, any one of the appropriate scene modes, if there is more than one) (No in step S20), the warning portion 233 givens a warning signal, based on which a warning is given to a photographer (step S30). After that, the processing proceeds to step S40.

In step S40, the CPU 17 selects one of the following operations to be performed: the currently selected scene mode is maintained, the currently selected scene mode is changed to the appropriate scene mode (or, any one of the appropriate scene modes, if there is more than one), and a default scene mode is entered after the currently selected scene mode is released. If the currently selected scene mode is changed, a scene mode newly selected is written in the memory 18.

Upon completion of step S40, the processing returns to step S10, and the operations carried out sequentially as described above are repeated at short intervals. With the operations of steps S10 and S20, it is possible to determine whether or not the currently selected scene mode is appropriate even while shooting of a moving image is in progress.

<Second Example of the Scene Mode Appropriateness Evaluating Portion>

Typically, a digital video camera that is equipped with a waterproof capability, or that can be housed inside a waterproof enclosure incorporates “Underwater” mode, which is optimum for underwater shooting, and in which white balance control optimum for underwater, and processing for reducing noise unique to an underwater environment are performed. When shooting is performed in shallow water, it is assumed that the shooting does not always take place underwater, and that the imaging apparatus may be submerged in and out of water. In this case, shooting is performed more satisfactorily if “Underwater” mode is released when the imaging apparatus comes out of water.

According to the processing flow depicted in FIG. 5, after a warning is given to a photographer, one of the following operations is performed in accordance with selection of a photographer: the currently selected scene mode is maintained, the currently selected scene mode is changed to the appropriate scene mode (or, any one of the appropriate scene modes, if there is more than one), and a default mode is entered after the currently selected mode is released. Accordingly, it is likely that a time lag is produced for releasing and changing the currently selected scene mode, and when the imaging apparatus is submerged in and out of water frequently, it is likely that shooting is not performed in an appropriate scene mode.

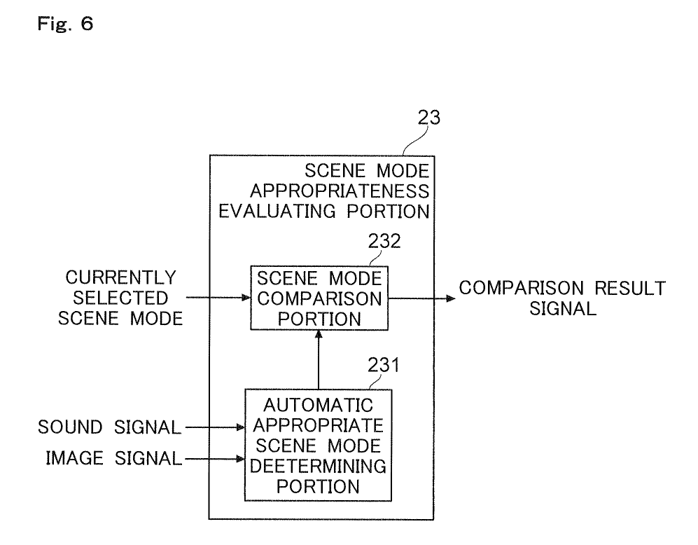

To overcome the inconveniences mentioned above, a second example of the scene mode appropriateness evaluating portion 23 is designed. The second example of the scene mode appropriateness evaluating portion 23 will be described with reference to FIG. 6. FIG. 6 is a block diagram showing a configuration of the second example of the scene mode appropriateness evaluating portion 23. In FIG. 6, the same parts as in FIG. 2 can be identified by the same reference signs.

The scene mode appropriateness evaluating portion 23 shown in FIG. 6 has a configuration same as in FIG. 2 with the warning portion 233 removed therefrom. The scene mode comparison portion 232 sends, to the CPU 17, a comparison result signal (indicating whether or not the currently selected scene mode corresponds to the appropriate scene mode or, any one of the appropriate scene modes, if there is more than one) (see FIG. 1).

Subsequently, the CPU 17, when receiving the comparison result signal indicating the currently selected scene mode does not correspond to the appropriate scene mode (or, any one of the appropriate scene modes, if there is more than one), automatically selects one of the following operations to be performed in accordance with a setting, written in the memory 18 in advance, for selecting an operation: the currently selected scene mode is maintained, the currently selected mode is changed to the appropriate scene mode (or, any one of the appropriate scene modes, if there is more than one), and a default scene mode is entered after the currently selected scene mode is released. If the currently selected scene mode is changed, a scene mode newly selected is written in the memory 18. It is desirable that a setting, written in the memory 18 in advance, for selecting an operation be altered by use of the operation portion 19.

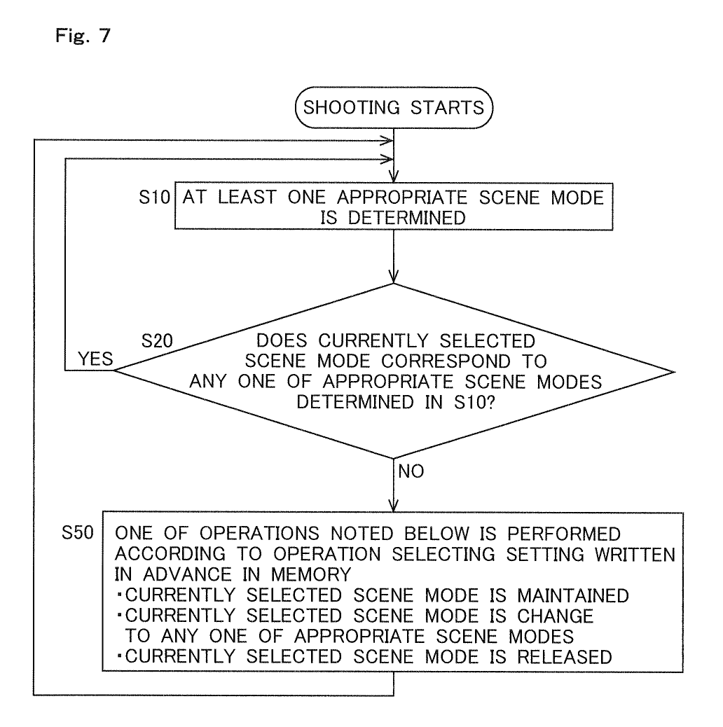

Accordingly, operations for shooting performed by the imaging apparatus shown in FIG. 1 and adopting the second example of the scene mode appropriateness evaluating portion 23 are summarized in a flowchart shown in FIG. 7. In FIG. 7, the same steps as in FIG. 5 can be identified by the same reference signs.

The flowchart shown in FIG. 7 is obtained by removing step S30 from FIG. 5, and by replacing step S40 shown in FIG. 5 with step S50.

In step S50, the CPU 17 selects one of the following operations to be performed in accordance with a setting, written in the memory 18 in advance, for selecting an operation: the currently selected scene mode is maintained, the selected scene mode is changed to the appropriate scene mode (or, any one of the appropriate scene modes, if there is more than one), and a default scene mode is entered after the currently selected scene mode is released. Then if the currently selected scene mode is changed, a scene mode newly selected is written in the memory 18. In step S50, if the selected scene mode is changed to the appropriate scene mode, or if the default scene mode is entered after the currently selected scene mode is released, the fact that the selected scene mode has been changed may or may not be notified to a photographer by showing a display on the display portion 12 or playing back a sound through the loudspeaker portion 15.

According to the processing flow depicted in FIG. 7, there is no need to give a warning to a photographer, and to select an operation in accordance with a command from a photographer. Thus, it is possible to avoid such an event where shooting cannot be performed in the appropriate scene mode due to a time lag produced for releasing and changing the currently selected scene mode.

<Example for Coping with Underwater Shooting>

Next, an example for coping with underwater shooting for a case where the second example of the scene mode appropriateness evaluating portion 23 is adopted will be described.

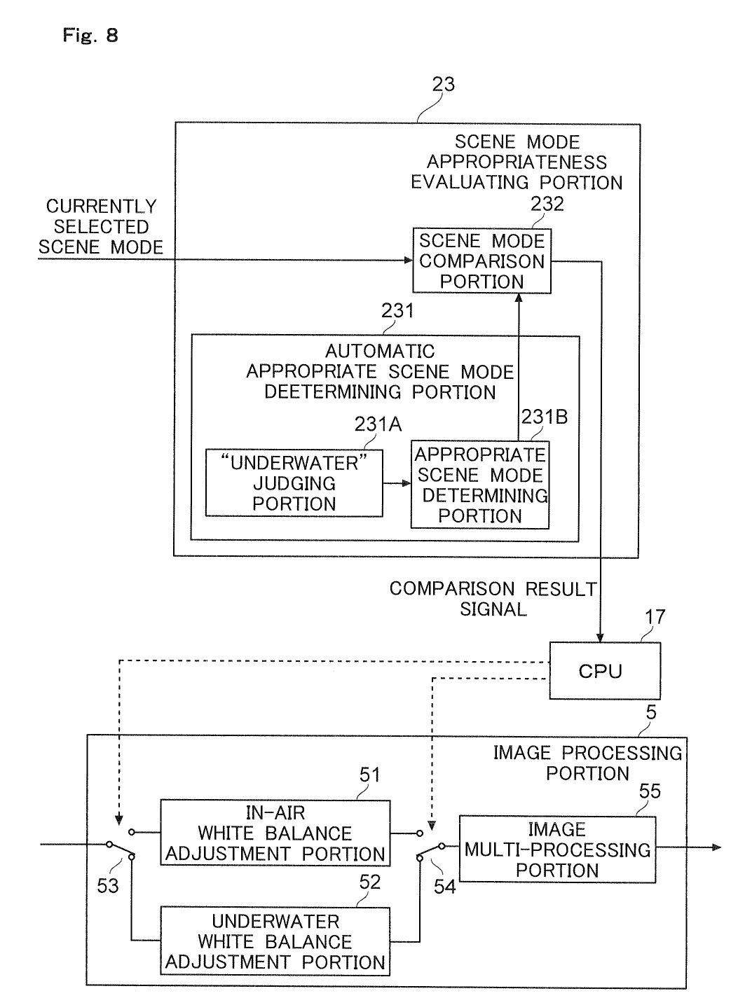

FIG. 8 shows parts of the imaging apparatus necessary for switching white balance adjustment depending on whether or not “Underwater” mode; in this figure, the scene mode appropriateness evaluating portion 23, the image processing portion 5, and the CPU 17 are shown. Here, the CPU 17 is to change the currently selected scene mode to an appropriate scene mode in accordance with a setting, written in the memory 18 (unillustrated in FIG. 18) in advance, for selecting an operation.

The automatic appropriate scene mode determining portion 231 inside the mode appropriateness evaluating portion 23 is provided with an “underwater” judging portion 231A and an appropriate scene mode determining portion 231B. The image processing portion 5 is provided with: an in-air white balance adjustment portion 51; an underwater white balance adjustment portion 52; switching portions 53 and 54; and an image multi-processing portion 55. The image multi-processing portion 55 may or may not be provided.

If the “underwater” judging portion 231A judges that a shooting environment is underwater, the appropriate scene mode determining portion 231B then determines that the appropriate scene mode is “Underwater” mode, and the CPU 17 enables, based on a comparison result signal, the switching portions 53 and 54 to select the underwater white balance adjustment portion 52. The underwater white balance adjustment portion 52 performs white balance adjustment based on water refractive characteristics.

On the other hand, if the “underwater” judging portion 231A judges that the shooting environment is not underwater, it is assumed that the shooting is performed in air, and thus, the appropriate scene mode determining portion 231B determines that the appropriate scene mode is “Normal (non-underwater)” mode. Then the CPU 17 enables, according to a comparison result signal, the switching portions 53 and 54 to select the in-air white balance adjustment portion 51. The in-air white balance adjustment portion 51 then adjusts white balance, for example, by use of an automatic setting.

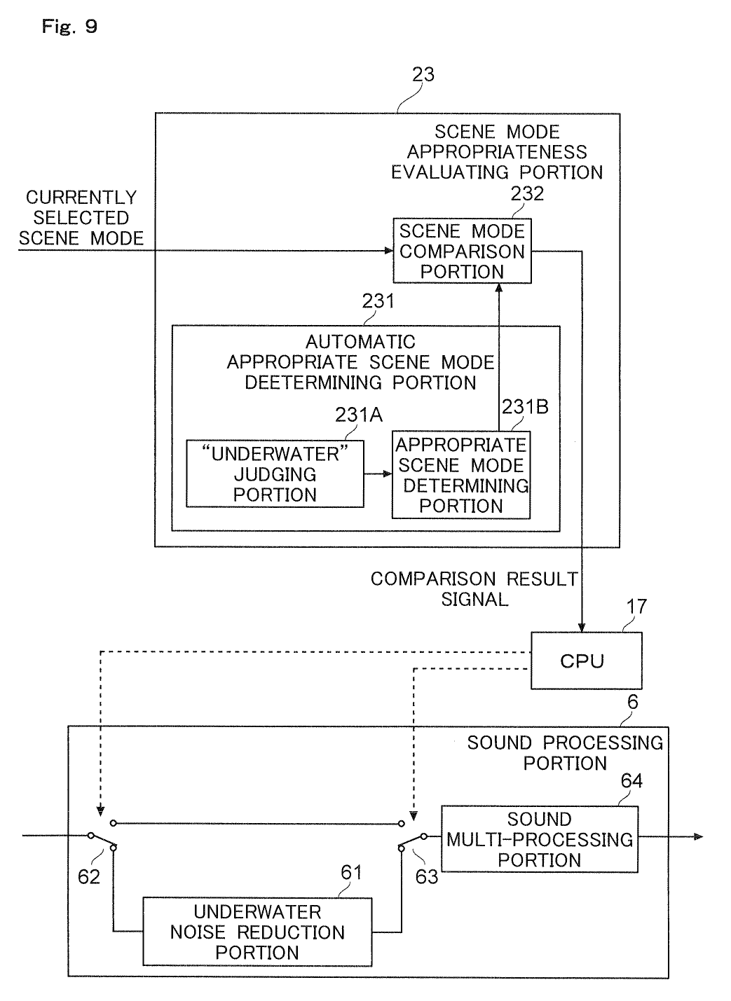

FIG. 9 shows parts of the imaging apparatus necessary for switching sound processing depending on whether or not the appropriate scene mode is “Underwater” mode; in this figure, the mode appropriateness evaluating portion 23, the audio processing portion 6, and the CPU 17 are shown. Here, the CPU 17 is to change the currently selected scene mode to an appropriate scene mode in accordance with a setting, written in the memory 18 (unillustrated in FIG. 9) in advance, for selecting an operation.

The automatic appropriate scene mode determining portion 231 inside the scene mode appropriateness evaluating portion 23 is provided with the “underwater” judging portion 231A and the appropriate scene mode determining portion 231B. The sound processing portion 6 is provided with: an underwater noise reduction portion 61; switching portions 62 and 63; and a sound multi-processing portion 64. The sound multi-processing portion 64 may or may not be provided.

If the “underwater” judging portion 231A judges that the shooting environment is underwater, the appropriate scene mode determining portion 231B determines that the appropriate scene mode is “Underwater,” and the CPU 17 enables, according to a comparison result signal, the switching portions 62 and 63 to select the underwater noise reduction portion 61. The underwater noise reduction portion 61 then performs noise reduction processing in consideration of acoustic characteristics unique to the underwater environment.

On the other hand, if the “underwater” judging portion 231A judges that the shooting environment is not underwater, it is assumed that shooting is performed in air, and thus, the appropriate scene mode determining portion 231B determines that the appropriate scene mode is “Normal (non-underwater)” mode. Then the CPU 17 enables, according to a comparison result signal, the switching portions 62 and 63 to select a through path.

<First Example of the “Underwater” Judging Portion>

Next, a first example of the “underwater” judging portion 231A will be described. In a first example of the “underwater” judging portion 231A, the “underwater” judging portion 231A is equipped with a pressure sensing portion. In a case where the first example of the “underwater” judging portion 231A is employed, a pressure sensor is newly added to the imaging apparatus shown in FIG. 1. In the “underwater” judging portion 231A, the pressure sensing portion is fed with a detection signal from the pressure sensor; if, according to the detection signal, a pressure outside the imaging apparatus is equal to or more than a predetermined threshold value, it is judged that the shooting environment is underwater, and if, according to the detection signal, the pressure outside the imaging apparatus is less than the predetermined threshold value, it is judged that the shooting environment is not underwater.

<Second Example of the “Underwater” Judging Portion>

Next, a second example of the “underwater” judging portion 231A will be described. In a second example of the “underwater” judging portion 231A, the “underwater” judging portion 231A is equipped with a frequency characteristics measuring portion.

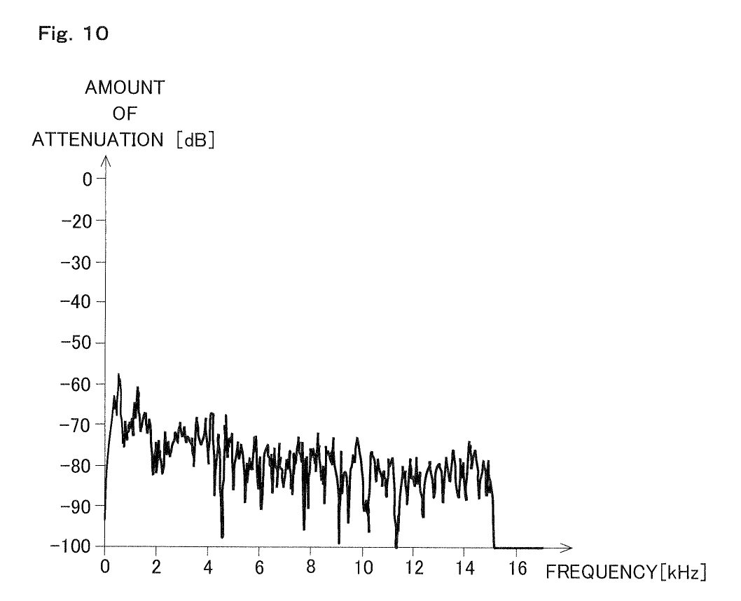

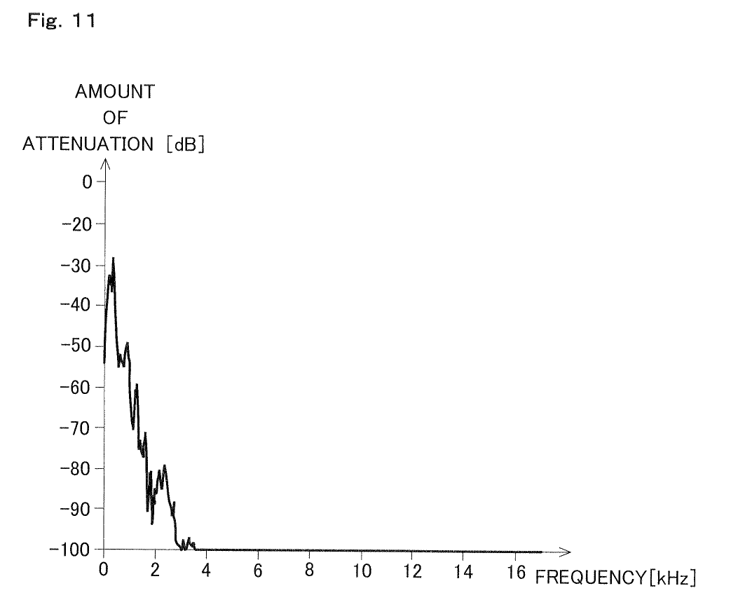

FIG. 10 shows frequency characteristics obtained by playing back a white noise in air and collecting it in air. Moreover, FIG. 11 shows frequency characteristics obtained by playing back a white noise in air and collecting it underwater.

The in-air sound collection exhibits generally flat frequency characteristics as shown in FIG. 10. On the other hand, the underwater sound collection typically exhibits frequency characteristics, indicating that signals within a high frequency range are greatly attenuated, so long as their levels are high, as shown in FIG. 11. This is because sounds are attenuated, owing to reflection, when transmitted through two interfaces, namely an interface between in-air and in-water and an interface between in-water and inside a housing of a sound collecting device (in-air), and typically low frequency components in sounds, such as a wave sound newly produced underwater and a sound newly produced inside the apparatus, are left accordingly.

As described above, when the imaging apparatus is used underwater, such a phenomenon as a difference in level arising between a sound with a low frequency and a sound with an intermediate or high frequency takes place, which is in fact unlikely to occur when the apparatus is used in air. Thus, taking advantage of this difference in signal level, a judgment is made whether or not the shooting environment is underwater.

Next, a judging method performed by the frequency characteristics measuring portion inside the “underwater” judging portion 231A will be described. Concerning R- and L-channel sound signals, an average value of signal level is calculated for each of frequency ranges, namely a low frequency range (e.g., from several tens (70) Hz to 3 kHz), an intermediate frequency range (e.g., from 6 kHz to 9 kHz), and a high frequency range (e.g., from 12 kHz to 15 kHz). Specific values for each of the frequency ranges are not limited to those mentioned above, and any value may be acceptable so long as a high-low relationship between the ranges is maintained properly. Moreover, the low frequency range and the intermediate frequency range may partially overlap each other, and the intermediate frequency and the high frequency may partially overlap each other.

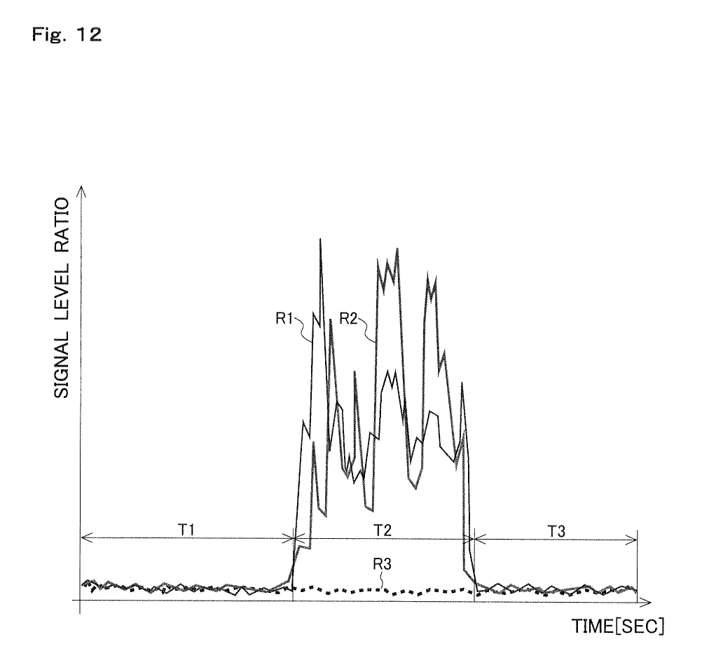

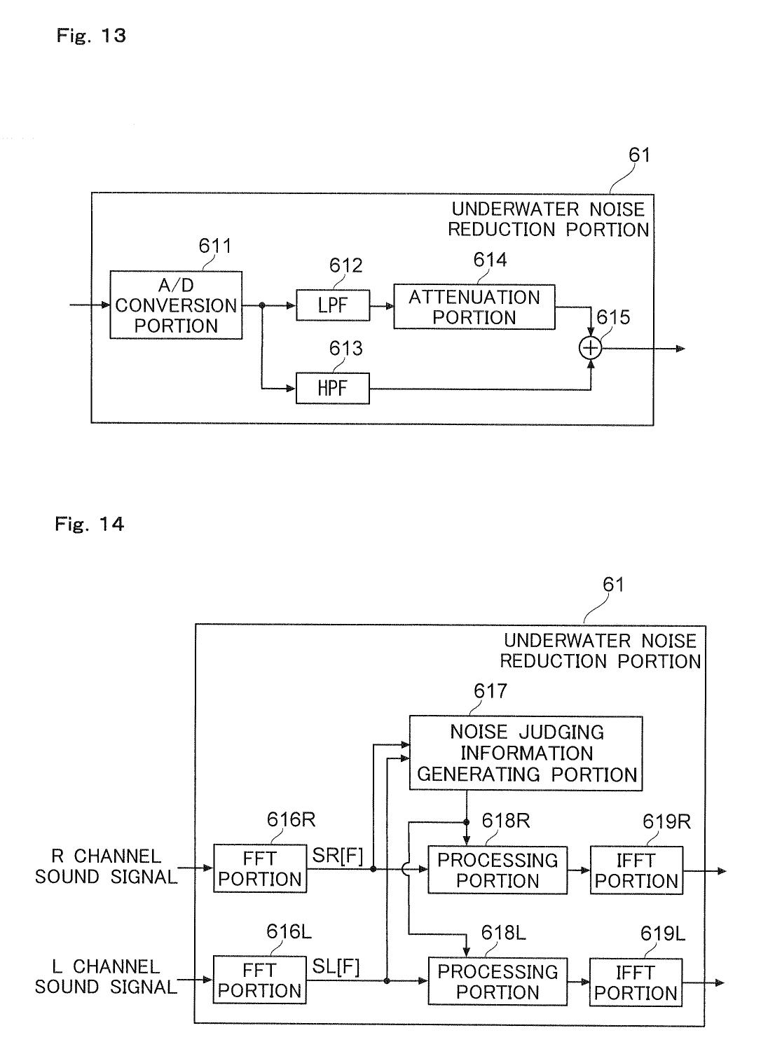

Using the average values of signal level thus obtained for each of the frequency ranges, a ratio R1 of a low frequency range signal level to a high frequency range signal level (low frequency range/high frequency range), a ratio R2 of a low frequency range signal level to an intermediate frequency range signal level (low frequency range/intermediate frequency range), and a ratio R3 of an intermediate frequency range signal level to a high frequency range signal level (intermediate frequency range/high frequency range) is calculated, each exhibiting a variation over time as shown in FIG. 12, in a case where the stereo microphone set 4 is once moved from in-air to in-water and then moved back to in-air again. In FIG. 12, periods T1 and T3 represent periods during which the stereo microphone set 4 is placed in air, and a period T2 represents a period during which the stereo microphone set 4 is placed underwater. The ratio R3 takes a substantially constant value, regardless of whether the imaging apparatus is in air or underwater. In contrast, the ratio R1 and the ratio R2 take small values during the periods when the imaging apparatus is in air, but they are comparatively greatly increased during the period when the apparatus is underwater owing to a change in its sound receiving sensitivity.

Taking advantage of this, the frequency characteristics measuring portion inside the “underwater” judging portion 231A calculates the ratios R1 and R2, using the average values of the signal level for each of the frequency range and, if the ratios R1 and R2 are equal to or more than predetermined threshold values, respectively, judges that the shooting environment is underwater. Moreover, although accuracy is lowered, the judgment may be made as follows: without calculating the average value of the intermediate frequency range signal level and the ratio R2 of the low frequency range signal level to the intermediate frequency range signal level, it is judged that the shooting environment is underwater if the ratio R1 of the low frequency range signal level to the high frequency range level (low frequency range/high frequency range) is equal to or more than its predetermined threshold value, or without calculating the average value of the high frequency range signal level and the ratio R1 of the low frequency range signal level to the high frequency range signal level, it is judged that the shooting environment is underwater if the ratio R2 of the low frequency range signal level to the intermediate frequency range signal level (low frequency range/intermediate frequency range) is equal to or more than its predetermined threshold value.

Even in water, noises are abruptly generated from sounds of bubbles or sounds produced by rubbing the housing, possibly causing an instantaneous increase in the intermediate and high frequency range signal levels and accordingly an instantaneous decrease in the ratio R1 of the low frequency range signal level to the high frequency range signal level (low frequency range/high frequency range) and the ratio R2 of the low frequency range signal level to the intermediate frequency range signal level (low frequency range/intermediate frequency range). It is therefore desirable that the frequency characteristics measuring portion inside the “underwater” judging portion 231A use, for making the judgment, a value averaged over a predetermined time for each of the ratios R1 and R2.

Moreover, it is desirable that the threshold values mentioned above be setup by adding a hysteresis so that they are high while it is judged that the shooting environment is in air, and that they are low while it is judged that the shooting environment is underwater.

<First Example of the Underwater Noise Reduction Portion>

Next, a first example of the underwater noise reduction portion 61 will be described. In this embodiment of the underwater noise reduction portion 61, the underwater noise reduction portion 61 is provided with: an A/D converter 611 converting a sound signal fed thereto; an LPF (low pass filter) 612 extracting and outputting therefrom a low frequency component, having a predetermined frequency or lower, of the sound signal fed from the A/D converter 611; an HPF (high pass filter) 613 extracting and outputting therefrom a high frequency component, having a predetermined frequency or higher, of the sound signal fed from the A/D converter 611; an attenuator 614 attenuating the low frequency component fed from the LPF 612; and a synthesizer 615 synthesizing the low frequency component fed from the attenuator 614 and the high frequency component fed from the HPF 613.

As shown in FIGS. 10 and 11, the frequency characteristics exhibited by the sound signal of a sound collected in air are different from those exhibited by the sound signal of a sound collected underwater. In the sound signal of a sound collected underwater in particular, a significant increase in intensity is observed around the low frequency range, differently from the sound signal of a sound collected in air. This may increase difficulty or annoyance in hearing the sound signal when played back, thus making the sound signal deviate from its waveform desired by a photographer.

However, the underwater noise reduction portion 61 configured as in this example can attenuate low frequency components in the sound signal of a sound collected underwater. Thus, it is possible to make the sound signal less affected by underwater sound collecting properties. That is, it is possible to effectively make the sound signal close to its waveform desired by a photographer.

Cut-off frequencies for the LPF 612 and the HPF 613 may be represented by a frequency λ1. Preferably, the frequency λ1 may be, for example, 2 kHz. Moreover, the amount of gain attenuation carried out by the attenuator 614 may be, for example, 20 dB.

Although this example deals with arrangements as described above where all components with the frequency λ1 or lower are attenuated by use of the LPF 612 and the HPF 613, what is attenuated thereby may be components in a predetermined frequency range. For this, the LFP 612 may be replaced by a BPF (band pass filter) permitting a component in a frequency range defined by the frequency λ1 as its upper limit and by a frequency λa as its lower limit to pass therethrough so that a component passing through the BPF is attenuated by the attenuator 614. Moreover, in this case, for example, the HPF 613 may be replaced by a BPF (band pass filter) permitting a component whose frequency ranges from the frequency λ1 to the frequency λa, inclusive, to pass therethrough.

<Second Example of the Underwater Noise Reduction Portion>

Next, a second example of the underwater noise reduction portion 61 will be described. In the second example of the underwater noise reduction portion 61, as shown in FIG. 14, the underwater noise reduction portion 61 is equipped with: FFT (fast Fourier transform) portions 616R and 616L; a noise judgment information generation portion 617; processing portions 618R and 618L; and IFFT (inverse fast Fourier transform) portions 619R and 619L.

The FFT portion 616R converts, into a digital signal, an R-channel sound signal fed from a microphone at a right side of the stereo microphone set 4 by performing sampling thereon at a rate of 48 kHz, and then transforms that digital signal into a signal SR[F] which is a representation of a frequency domain, by performing FFT processing thereon for every 2048 samples. The FFT portion 616L converts, into a digital signal, an L-channel sound signal fed from a microphone at a left side of the stereo microphone set 4 by performing sampling thereon at a rate of 48 kHz, and then transforms that digital signal into a signal SL[F] which is a representation of a frequency domain, by performing FFT processing thereon for every 2048 samples.

The noise judgment information generation portion 617 generates, using the signals SR[F] and SL[F] in the frequency domain fed from the FFT portions 616R and 616L, respectively, information necessary for judging whether or not a relevant sound component is a noise from the imaging apparatus itself.

The processing portion 618R performs sound processing on the signal SR[F] in the frequency domain, using the information provided from the noise judgment information generation portion 617 so as to reduce effects from noises coming from the imaging apparatus itself when collecting sounds, and the processing portion 618L performs sound processing on the signal SL[F] in the frequency domain, using the information provided from the noise judgment information generation portion 617 so as to reduce effects from noises coming from the imaging apparatus itself when collecting sounds.

<First Example of the Noise Judgment Information Generation Portion>

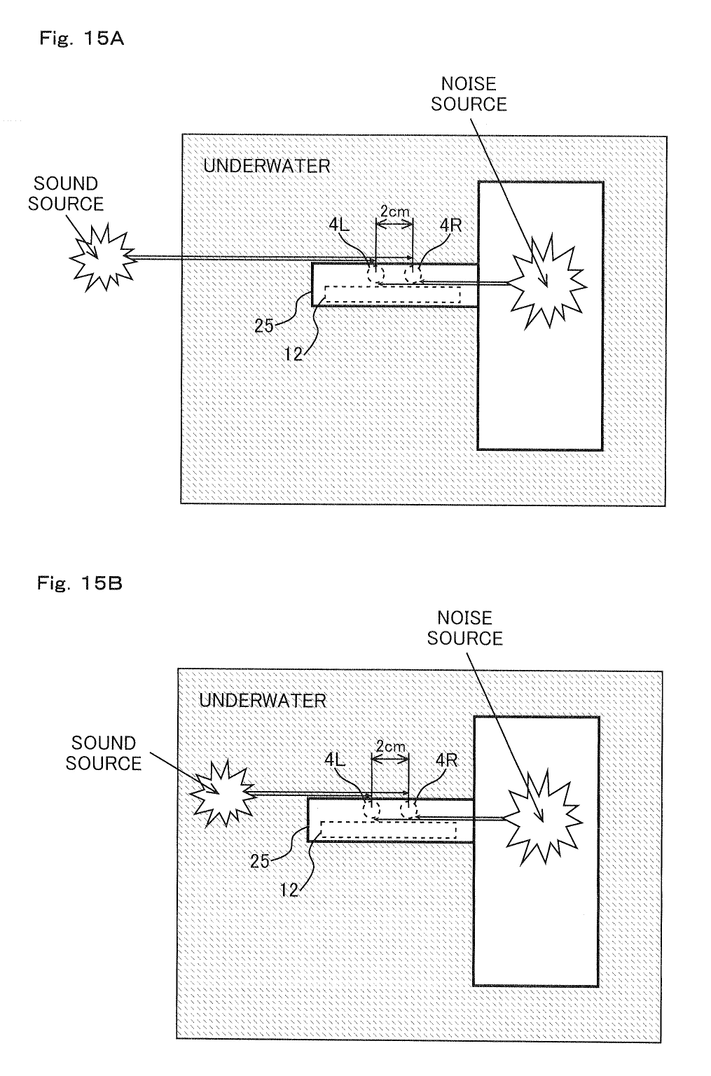

A first example of the noise judgment information generation portion 617 will be described with reference to FIGS. 15A and 15B. In the first example of the noise judgment information generation portion 617, the noise judgment information generation portion 617 is equipped with a relative phase difference information generation portion. FIGS. 15A and 15B are diagrams each showing how a sound propagates from a noise source in the body of the imaging apparatus and from a sound source from which a sound to be collected originates.

For uniquely determining a relative phase difference between two sound signals that represent sounds collected by two microphones, half a wavelength of a sound signal needs to be longer than a distance between the two microphones. Thus, in a case where the distance between two microphones 4R and 4L is 2 cm as shown in FIGS. 15A and 15B, let a velocity of a sound measured in air be 340 m/s, and then the relative phase difference information generation portion inside the noise judgment information generation portion 617 can generate relative phase difference information only for sound signals whose frequencies are equal to or lower than 8.5 kHz.

A noise such as a motor sound produced by the imaging apparatus itself is transmitted through a hollow space inside the housing of the imaging apparatus (in air), and then reaches each of the microphones 4R and 4L. Such a noise yields a difference between a phase of its part reaching the right-side microphone 4R and a phase of its part reaching the left-side microphone 4L, namely a relative phase difference Δφ0, which can be expressed by formula (1) noted below, where Freq represents a frequency of a target noise for which a relative phase difference is to be obtained.

Δφ0=2π×(Freq×20/340000) (1)

A difference between a phase of a sound propagating through water and then reaching the right-side microphone 4R and a phase of the same sound reaching the left-side microphone 4L (relative phase difference) is largest if it propagates through water and approaching from a side of the imaging apparatus as shown in FIGS. 15A and 15B, and this relative phase difference Δφ1 can be expressed, based on the fact that a velocity of a sound measured underwater is five times a velocity of a sound measured in air, by formula (2) noted below, where Freq represents a frequency of a target sound for which a relative phase difference is to be obtained. Where a sound propagating through water enters a monitor unit 25, in which that sound travels through air before reaching the microphones 4R and 4L, individual sound propagation paths through which the sound passes from the monitor unit 25 to the microphones 4R and 4L are substantially same in length. Moreover, part of the sound propagation path inside the monitor unit 25 (in air) has a length extremely short as compared with a sound propagation path in water through which the same sound has propagated. Thus, the length of the sound propagation path inside the monitor unit 25 (in air) may be ignored in consideration of a relative phase difference of a sound propagating through water. Moreover, as shown in FIG. 15A, even in a case where an intended sound source from which a target sound to be collected originates is present in air, two sound propagation paths from the sound source in air to an interface between in-air and in-water are substantially same in length. Thus, the lengths of the sound propagation paths from the sound source in air to the interface between in-air and in-water may be ignored.

Δφ1=2π×{Freq×20/(340000×5)} (2)

The relative phase difference information generation portion inside the noise judgment information generation portion 617 compares a phase of the signal SR[F] in the frequency domain with a phase of the signal SL[F] in the frequency domain, and generates, based on the comparison, information indicating a difference between a phase of a sound reaching the right-side microphone 4R and a phase of the same sound reaching the left-side microphone 4L, namely relative phase difference information therebetween. The relative phase difference comparison portion inside the noise judgment information generation portion 617 obtains a relative phase difference at a rate of 2048/48000 [Hz] that is a resolution of the FFT portions 616R and 616L.

As described above, the relative phase difference of a sound propagating through water s equal to or less than Δφ1, and the relative phase difference of a noise produced by the imaging apparatus is Δφ0(=5×Δφ1). Thus, a frequency component whose relative phase difference is equal to or less than Δφ1 can be judged as a frequency component of a sound propagating through water.

<Second Example of the Noise Judgment Information Generation Portion>

Next, a second example of the noise judgment information generation portion 617 will be described. In the second example of the noise judgment information generation portion 617, the noise judgment information generation portion 617 is equipped with a relative level difference information generation portion.

It is known that the rate of underwater sound attenuation is very low. In addition, it is also known that generally sound attenuation by distance is increased as a sound source is close. Accordingly, sounds reaching the microphones 4R and 4L, respectively, from outside the imaging apparatus are attenuated at a low rate, and hardly any difference arises between a signal level of the right-side microphone 4R and a signal level of the left-side microphone 4L. On the other hand, a noise propagating through the hollow space of the housing of the imaging apparatus (in air) and reaching the microphones 4R and 4L yields a large difference between a signal level of the right-side microphone 4R and a signal level of the left-side microphone 4L. This is because a noise propagates in air, because a distance from a noise source to the microphones 4R and 4L is short, and because a noise is attenuated owing to absorption when it is reflected inside the housing.

The relative level difference information generation portion inside the noise judgment information generation portion 617 compares a level of the signal SR[F] in the frequency domain with a level of the signal SL[F] in the frequency domain, and generates, based on the comparison, information indicating a difference between a level of a sound reaching the right-side microphone 4R and a level of the same sound reaching the left-side microphone 4L, namely relative level difference information. The relative level difference information generation portion inside the noise judgment information generation portion 617 obtains a relative level difference at a rate of 2048/48000 [Hz] that is a resolution of the FFT portions 616R and 616L.

Thus, the relative level difference of a sound propagating through water is large, whereas the relative level difference of a noise produced by the imaging apparatus is small. This makes it possible to judge a frequency component whose relative level difference obtained by the relative level difference information generation portion inside the noise judgment information generation portion 617 is equal to or more than a predetermined threshold value as a frequency component of a sound propagating through water.

The first and second examples may be combined in practicing the noise judgment information generation portion 617. That is, the noise judgment information generation portion 617 may generate both the relative phase difference information and the relative level difference information. By using both the relative phase difference information and the relative level information, it is possible to increase accuracy in making the judgment.

<First Example of the Processing Portions>

Next, a first example of the processing portions 618R and 618L will be described. In the first example of the processing portions 618R and 618L, the processing portions 618R and 618L are each equipped with a reduction processing portion.

Each of the reduction processing portions inside the processing portions 618R and 618L compares the noise judgment information provided from the noise judgment information generation portion 617 with a threshold value (e.g., for a case where the first example is adopted for the noise judgment information generation portion 617, Δφ1 obtained by applying the above-described formula (2)), and then judges, based on the comparison, whether or not the signals SR[F] and SR[F] in the frequency domain are noise components produced by the imaging apparatus itself at a rate of 2048/48000 [Hz] that is a resolution of the FFT portions 616R and 616L. Then each of the reduction processing portions performs reduction by −20 dB on a frequency component that is judged as a noise produced by the imaging apparatus, and performs no reduction on a frequency component that is not judged as a noise produced by the imaging apparatus.

In a case where the first example is adopted for the processing portions 618R and 618L, if the first example is adopted for the noise judgment information generation portion 617, such reduction is performed simply on a frequency component having a large phase difference between the signal SR[F] and the signal SL[F] in the frequency domain. This offers an advantage that even if the “underwater” judgment portion 231A makes an erroneous judgment on a sound collecting environment, since no reduction is performed on sounds in a forward direction in which the imaging apparatus is shooting, adverse effects owing to the erroneous judgment are small.

<Second Example of the Processing Portions>

Next, a second example of the processing portions 618R and 618L will be described. In the second example of the processing portions 618R and 618L, the processing portions 618R and 618L are each equipped with an emphasis processing portion.

Each of the emphasis processing portions inside the processing portions 618R and 618L compares the noise judgment information provided from the noise judgment information generation portion 617 with a threshold value (e.g., for a case where the first example is adopted for the noise judgment information generation portion 617, Δφ1 obtained by applying the above-described formula (2)), and then judges, based on the comparison, whether or not the signals SR[F] and SL[F] in the frequency domain are noise components produced by the imaging apparatus itself at a rate of 2048/48000 [Hz] that is a resolution of the FFT portions 616R and 616L. Then each of the emphasis processing portions performs emphasis (amplification) on a frequency component that is not judged as a noise produced by the imaging apparatus, and performs no emphasis (no amplification) on a frequency component that is judged as a noise produced by the imaging apparatus. A degree of the emphasis may be constant irrelevant to a frequency value, or may be variable depending on a frequency value (e.g., the emphasis may be weakened at the low frequency range, and may be intensified at the intermediate and high frequency ranges, in consideration of the frequency characteristics shown in FIG. 11).

Frequency components other than those judged as a noise by the processing portions 618R and 618L are of sounds inherent in the underwater environment and propagating through water. Sounds originating in and propagating through water are reflected at an interface between water and air, and are thus greatly attenuated. Accordingly, the processing 618R and 618L in the second example are adopted to perform emphasis (amplification) on frequency components other than those judged as a noise, making it possible to make underwater-specific sounds closer to levels they ought to exhibit.

The first and second examples may be combined in practicing the processing portions 618R and 618L. That is, the processing portions 618R and 618 may be so arranged as to reduce a frequency component that is judged as a noise produced by the imaging apparatus, and to emphasize (amplify) a frequency component that is not judged as a noise produced by the imaging apparatus.

<Modified Example>

In the imaging apparatus shown in FIG. 1, the stereo microphone set 4 is employed; however, other type of microphones composed of a plurality of microphones (e.g., 5.1 channel surround sound microphones) may be employed.

Moreover, it is desirable that the imaging apparatus according to the present invention be so formed as to have a waterproof structure; however, instead of being structured as a waterproof apparatus, the imaging apparatus according to the present invention may adopt a usage in which the apparatus is housed, for example, inside a waterproof enclosure and receives sound signals of a sound collected by a microphone outside the apparatus.

The present invention is applicable to an imaging apparatus incorporating a plurality of scene modes, and to a scene mode appropriateness evaluating method for evaluating whether or not a scene mode currently selected by such an imaging apparatus is appropriate. Moreover, the present invention is applicable to any other electronic device (e.g., IC recorder, etc.) incorporating a plurality of recording modes, and to a recording mode appropriateness evaluating method for evaluating whether or not a recording mode currently selected by such an electronic device, thus making it possible to evaluate whether or not a currently selected recording mode is appropriate, during recording.

What is claimed is:

1. An imaging apparatus incorporating a plurality of scene modes, comprising:
an automatic appropriate scene mode determining portion that, while shooting of a moving image is in progress, automatically determines at least one scene mode appropriate for a shooting scene of the moving image; and
a scene mode comparison portion that, while the shooting of the moving image is in progress, compares a currently selected scene mode with the at least one scene mode automatically determined by the automatic appropriate scene mode determining portion, and that thereby confirms whether or not the currently selected scene mode corresponds to any one of the at least one scene mode automatically determined by the automatic appropriate scene mode determining portion.

2. The imaging apparatus according to claim 1, further comprising
a control portion,
wherein if the scene mode comparison portion confirms that the currently selected scene mode does not correspond to any one of the at least one scene mode automatically determined by the automatic appropriate scene mode determining portion, the control portion performs one of operations in which the currently selected scene mode is maintained, in which the currently selected scene mode is changed to any one of the at least one scene mode automatically determined by the automatic appropriate scene mode determining portion, and in which the currently selected scene mode is released.

3. The imaging apparatus according to claim 1, further comprising
a warning portion,
wherein if the scene mode comparison portion confirms that the currently selected scene mode does not correspond to any one of the at least one scene mode automatically determined by the automatic appropriate scene mode determining portion, the warning portion gives a warning that the currently selected scene mode does not correspond to any one of the at least one scene mode automatically determined by the automatic appropriate scene mode determining portion.

4. The imaging apparatus according to claim 2, further comprising
a warning portion,
wherein if the scene mode comparison portion confirms that the currently selected scene mode does not correspond to any one of the at least one scene mode automatically determined by the automatic appropriate scene mode determining portion, the warning portion gives a warning that the currently selected scene mode does not correspond to any one of the at least one scene mode automatically determined by the automatic appropriate scene mode determining portion.

5. The imaging apparatus according to claim 4, further comprising
an operation portion through which a command from a photographer is entered,
wherein in accordance with an output signal generated by the operation portion based on the command which the photographer has entered in response to the warning given by the warning portion, the control portion performs one of operations in which the currently selected scene mode is maintained, in which the currently selected scene mode is changed to the scene mode automatically determined by the automatic appropriate scene mode determining portion, and in which the currently selected scene mode is released.

6. The imaging apparatus according to claim 1,
wherein each of the plurality of scene modes, associated with each differently categorized shooting scene, has a setting in which at least one of camera control for shooting the moving image, image processing for an image signal obtained by shooting the moving image, and sound processing for a sound signal obtained by shooting the moving image is setup appropriately for a kind of the shooting scene.

7. The imaging apparatus according to claim 6,
wherein the plurality of scene modes include “Underwater” mode appropriate for underwater shooting.

8. In an imaging apparatus incorporating a plurality of scene modes, a scene mode appropriateness evaluating method for evaluating whether or not a scene mode currently selected by the imaging apparatus is appropriate, comprising the steps of:
while shooting of a moving image is in progress,
(1) automatically determining at least one scene mode appropriate for a shooting scene, and
(2) comparing whether or not the currently selected scene mode with the at least one scene mode automatically determined in the step (1), and thereby confirming whether or not the currently selected scene mode corresponds to any one of the at least one scene mode automatically determined in the step (1).

9. The scene mode appropriateness evaluating method according to claim 8, further comprising the step of:
(3) if it is confirmed, in the step (2), that the currently selected scene mode does not correspond to any one of the at least one scene mode automatically determined in the step (1),
performing one of operations in which the currently selected scene mode is maintained, in which the currently selected scene mode is changed to the scene mode automatically determined in the step (1), and in which the currently selected scene mode is released.

10. The scene mode appropriateness evaluating method according to claim 8, further comprising the step of:
(4) if it is confirmed, in the step (2), that the currently selected scene mode does not correspond to any one of the at least one scene mode automatically determined in the step (1),
giving a warning that the currently selected scene mode does not correspond to any one of the at least one scene mode automatically determined in the step (1).

11. The scene mode appropriateness evaluating method according to claim 9, further comprising the step of:
(4) if it is confirmed, in the step (2), that the currently selected scene mode does not correspond to any one of the at least one scene mode automatically determined in the step (1),
giving a warning that the currently selected scene mode does not correspond to any one of the at least one scene mode automatically determined in the step (1).

12. The scene mode appropriateness evaluating method according to claim 11,
the imaging apparatus further comprising an operation portion through which a command from a photographer is entered, and
the method further comprising the step of:
in the step (3),
(5) in accordance with an output signal generated by the operation portion based on the command which the photographer enters after the step (4) is executed,
selecting and performing one of operations in which the currently selected scene mode is maintained, in which the currently selected scene mode is changed to the scene mode automatically determined in the step (1), and in which the currently selected scene mode is released.

13. The scene mode appropriateness evaluating method according to claim 8,
wherein each of the plurality of scene modes, associated with each differently categorized shooting scene, has a setting in which at least one of camera control for shooting the moving image, image processing for an image signal obtained by shooting the moving image, and sound processing for a sound signal obtained by shooting the moving image is setup appropriately for a kind of the shooting scene.

14. The scene mode appropriateness evaluating method according to claim 13,
wherein the plurality of scene modes include “Underwater” mode appropriate for underwater shooting.
